(19) United States
(12) Patent Application Publication
(10) Pub. No.: US 2009/0099854 A1
(43) Pub. Date: Apr. 16, 2009

(54) SELF-MONITORING SYSTEM OF RECIPROCAL BENEFIT

(75) Inventor: Cynthia Johanson, San Francisco, CA (US)

Correspondence Address: BEYER LAW GROUP LLP/YAHOO, PO BOX 1687, CUPERTINO, CA, 95015-1687, US

(73) Assignee: YAHOO! INC., Sunnyvale, CA (US)

(21) Appl. No.: 11/870,345

(22) Filed: Oct. 10, 2007

(51) Int. Cl. G06Q 10/00

(52) U.S. Cl. 705/1

(57) ABSTRACT

In one embodiment, an indication that a first user of a social network has performed an action relating to helping a second user of the social network is received. Then a number of points is awarded to the first user based on the action performed. Then a web page is delivered to a third user, wherein the web page contains an identification of the first user and a representation of the number of points the first user has been awarded, wherein the number of points the first user has been awarded are delivered in a way that allows them to be used to benefit the first user.

### BACKGROUND OF THE INVENTION

1. Field of the Invention

The present invention relates to social network connections. More particularly, the present invention relates to a self-monitoring system of reciprocal benefit.

2. Description of the Related Art

A person's social network can be important for improving a person's personal life, such as in finding people with similar interests, making new friends, and finding a mate. However, social networks can be of increased importance for a person's professional life at particular points in one's life or for certain segments of society. Recent college graduates, for example, typically find it difficult to transition from their lives as college students into lives in their chosen career. One of the primary difficulties in this transition is in finding a job, as college graduates typically have little or no work experience. Furthermore, in addition to help in finding a job, many recent college graduates rely on their social network connections for career advice.

### SUMMARY OF THE INVENTION

In one embodiment, an indication that a first user of a social network has performed an action relating to helping a second user of the social network is received. Then a number of points is awarded to the first user based on the action performed. Then a web page is delivered to a third user, wherein the web page contains an identification of the first user and a representation of the number of points the first user has been awarded, wherein the number of points the first user has been awarded are delivered in a way that allows them to be used to benefit the first user.

### BRIEF DESCRIPTION OF THE DRAWINGS

FIGS. 1 and 2 are diagrams illustrating examples of a social network expressed as a series of nodes having directed edges in accordance with an embodiment of the present invention.

FIG. 3 is a flow diagram illustrating a method in accordance with an embodiment of the present invention.

FIG. 4 is a block diagram illustrating an apparatus in accordance with an embodiment of the present invention.

FIG. 5 is a flow diagram illustrating a method for utilizing good deed points awarded to a first user in a social network in accordance with an embodiment of the present invention.

FIG. 6 is an exemplary network diagram illustrating some of the platforms that may be employed with various embodiments of the invention.

### DETAILED DESCRIPTION OF SPECIFIC EMBODIMENTS

Reference will now be made in detail to specific embodiments of the invention including the best modes contemplated by the inventors for carrying out the invention. Examples of these specific embodiments are illustrated in the accompanying drawings. While the invention is described in conjunction with these specific embodiments, it will be understood that it is not intended to limit the invention to the described embodiments. On the contrary, it is intended to cover alternatives, modifications, and equivalents as may be included within the spirit and scope of the invention as defined by the appended claims. In the following description, specific details are set forth in order to provide a thorough understanding of the present invention. The present invention may be practiced without some or all of these specific details. In addition, well known features may not have been described in detail to avoid unnecessarily obscuring the invention.

In accordance with the present invention, the components, process steps, and/or data structures may be implemented using various types of operating systems, computing platforms, computer programs, and/or general purpose machines. In addition, those of ordinary skill in the art will recognize that devices of a less general purpose nature, such as hardwired devices, field programmable gate arrays (FPGAs), application specific integrated circuits (ASICs), or the like, may also be used without departing from the scope and spirit of the inventive concepts disclosed herein.

A social network may be established to represent sets of nodes with varying degrees of separation. These nodes may be arranged with directed edges that establish connections between the nodes. The nodes can represent persons, locations, entities, information and the like. Connections may even be weighed based on relationship strength or other factors.

The social network may be overseen by a single entity or by multiple entities. Data relating to the social network may be stored in one or more servers accessible via the Internet. Users may then interact with web pages describing themselves and other users of the social network. Operations performed by the users with respect to the social network may be executed by the one or more servers. These operations may include modification of user profiles, communications with other users, and reviewing other user's profiles, among others.

In accordance with an embodiment of the present invention, connections between people are mapped and the individuals may be assigned points for performing good deeds with respect to other nodes within the social network. These points may be utilized in many different ways. A user's points may be displayed for others to see. This can have direct benefit to the user, but may also benefit the users doing the viewing. For example, a job recruiter may take the number of “good deed” points that a candidate has in determining whether or not to offer a job interview in an interview schedule having limited spots. Likewise a potential date may be more likely to agree to go out with a user having a large number of “good deed” points. Additionally, advice or news information offered by a user having a large number of “good deed” points may be favored over advice or news information offered by users having few or no “good deed” points.

The reward for good deed points may alternatively be more automated. For example, if a job recruiter performs a search for potential job candidates, the system may select to display only those potential candidates with the highest number of good deed points. In another example, the job recruiter may select to rank the potential job candidates by their numbers of good deed points.

Points may be awarded for a variety of good deeds. This may include getting a job for another member of the social network, giving advice to another member, helping fix a resume, providing suggestions on careers, connecting one user to another, etc. As such, the term “good deed” shall be interpreted to mean any action that helps another member of the social network and does not directly result in a financial gain for the person performing the good deed. This definition helps to distinguish the good deed from, for example, a business transaction.

The good deed points may be accumulated and tracked in many different ways. In one embodiment, a server maintains good deed point totals for members of the social network. In another embodiment, good deed point totals may be encrypted and stored on the member's computer.

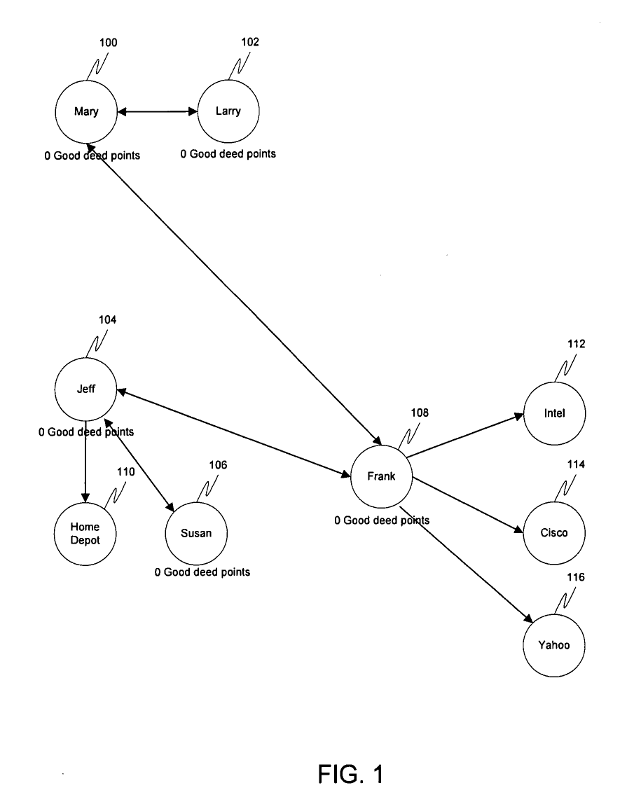

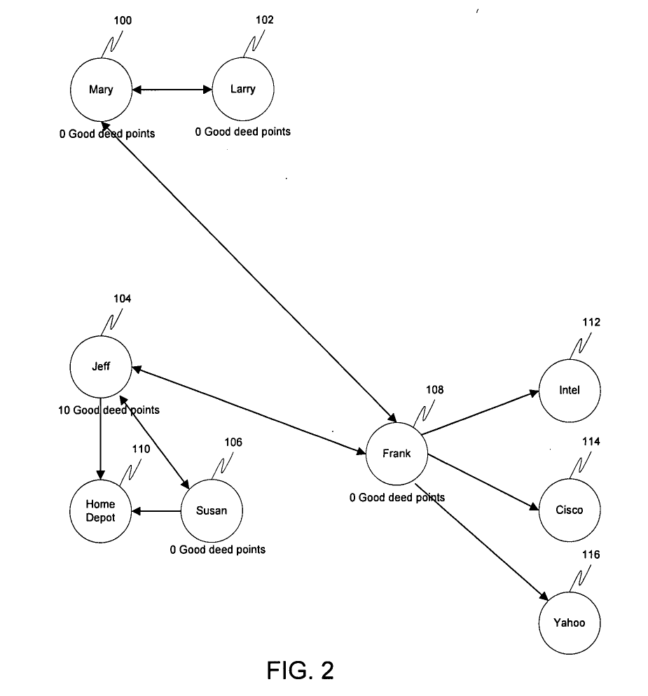

FIG. 1 is diagram illustrating an example of a social network expressed as a series of nodes having directed edges in accordance with an embodiment of the present invention. This social network includes Mary 100, who went to the same school that Larry 102 is attending, as well as Jeff 104, who went to the same school that Susan 106 is attending. Jeff also has a connection to Home Depot 108, where he used to work. Both Mary 100 and Jeff 104 are attempting to find jobs in high technology, and contact job recruiter Frank 110, who has connections to Intel 112, Cisco 114, and Yahoo 116. Since both Mary and Jeff have the same number of good deed points (0), Frank treats them equally in job placement. Referring to FIG. 2, however, here Jeff 104 helps Susan 106 get a job at Home Depot 108. As such, he has been awarded 10 Good deed points. Now, when Frank attempts to place Jeff 104 in the high technology industry, Frank 110 and/or Intel 112, Cisco 114, and Yahoo! 116 have a basis on which to place Jeff 104 ahead of Mary 100.

In another example, Fred emails Laurie for career advice. A field is then inserted into the bottom of Laurie's return email asking Fred to rate how “helpful” Laurie's advice has been. Laurie's good deed point total may then rise (or lower) based upon the rating that Fred has assigned. Subsequent emails from Fred to other people looking for advice may contain similar fields, and Fred's good deed point total may be adjusted based upon their ratings as well. In some embodiments, it may also be beneficial to limit the number that a good deed point total can be altered by a single user's ratings. For example, if Fred continuously emails Laurie for advice, it might be beneficial to weigh subsequent ratings from Fred less heavily than the initial rating, in order to prevent malicious (or innocent) manipulation of the good deed points system by a single user.

In another example, John provides an online profile that includes information about his career and the company for which he works. This profile is viewed by many college students who rely on it as a mechanism to learn more about a potential career and/or place to work. The profile may include a field allowing users to rate “how helpful” John's profile is. Ratings provided by the various college students may then be used to adjust Fred's good deed point total. This encourages John to have a well-vetted profile that acts to teach other network members about potential careers or places to work, as opposed to making the profile purely self-serving.

In another example, a web page is provided to allow people to anonymously give good deed points to another. Care must be taken in such an instance to prevent fraud or manipulation, however controls can be put into place to limit such actions, such as the user giving the points not being anonymous to the social network operator, merely to the person to whom he or she is granting good deed points.

In another example, Adrienne requests a connection to Frank through Steve. If Steve passes along this connection, then Steve may be awarded good deed points.

In another example, users of the social network that add connections to their profile accumulate good deed points for doing so. The more connections added, the more good deed points. This aids the social network in weeding out one-time-only users, who merely join and then do nothing but take up space. This encourages and rewards users to be active members of the social network as opposed to passive. Additional incentives can be provided to promote activity among users, including, for example, awarding good deed points weekly as long as the user logs in to his account during the week.

In another example, when a student views representatives of a company, those with the highest number of good deed points may be placed more prominently on the web page. This would enable students to contact representatives with the highest probability of providing them with useful career advice and/or help. Privacy features may also be implemented so that those users with high good deed point totals can control the number of people who contact them.

In another example, where company recruiters choose to help students and/or provide career advice, the recruiters may be rewarded by adding to their good deed point totals. This provides company recruiters with a single spot to which they can point their bosses to show how much networking they are performing and the number of good will they have generated.

In another example, college professors may be rewarded with good deed points for helping students (either reach professional or personal goals). These good deed points may then be used to show the value these professors add to the school, which may be helpful when determining whether or not to offer these professors tenure.

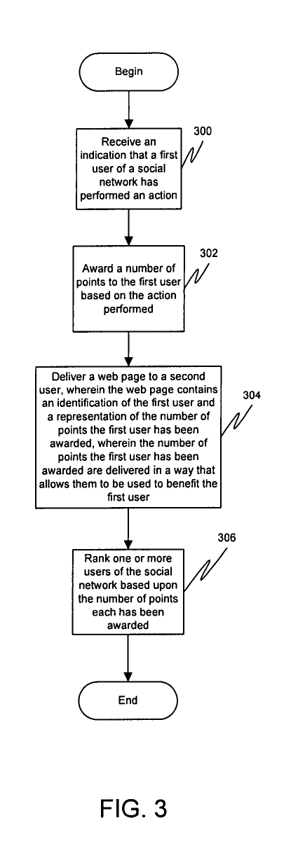

FIG. 3 is a flow diagram illustrating a method in accordance with an embodiment of the present invention. Each step of this method may be implemented in hardware, software, or any combination thereof. At 300, an indication that a first user of a social network has performed an action relating to helping a second user of the social network is received. For purposes of this document, the phrase “relating to helping a second user of the social network” shall be interpreted to mean any action that directly or indirectly aids the second user. In one embodiment, this action must be voluntary, as opposed to involuntary or accidental. This action may be, for example, that the first user has gotten a job for the second user of the social network, or provided advice to the second user of the social network. The action may either be initiated through electronic means, such as, for example, by responding to an email or providing an enlightening web page, or through non-electronic means, such as by getting a job for someone or meeting them for lunch to provide in-person advice. As mentioned above, the action may be virtually any action that helps another member of the social network and does not directly result in a financial gain for the person performing the good deed.

At 302, a number of points are awarded to the first user based on the action performed. This may be awarded at the time the action is performed or at any time later. The awarding may be automatic or may be initiated by another user (such as the second user, who is helped by the action). The awarding may involve crediting an account created for the first user on a server that is accessible via the Internet. The number of points that are awarded may be determined by many different mechanisms. In one embodiment, a list may be maintained that correlates various types of good deeds with various point levels. When a potential good deed is performed, this list may be accessed and the corresponding point level may be awarded to the user who performed the good deed. In another embodiment, the user receiving the benefit of the good deed may partially or entirely control the number of points awarded to the user performing the good deed. For example, the user receiving the benefit of the good deed may be allowed to grant zero to five points to the user who performed the good deed.

At 304, a web page is delivered to a third user, wherein the web page contains an identification of the first user and a representation of the number of points the first user has been awarded, wherein the number of points the first user has been awarded are delivered in a way that allows them to be used to benefit the first user. The third user may be an individual user or alternatively may be a company or other non-individual entity. The delivering may include formatting the web page such that the identification of the first user appears in lieu of or more prominently than an identification of a fourth user if the first user has been awarded more points than the third user. More prominently may include appearing higher up on the page or in a larger size, for example. The representation of the number of points the first user has been awarded may be an absolute number or some sort of relative representation. For example, the representation may simply list the number of points awarded to the first user, or alternatively may indicate that the user has been awarded a “high,” “average,” or “low” amount of points. Additionally, the representation may either be explicitly shown on the web page, such as by listing the total or providing a graphical representation of the relative amount of points, or may be implicit by, for example, showing a first user higher up on the page than a second user. At 306, one or more users of the social network may be ranked based upon the number of points each has been awarded.

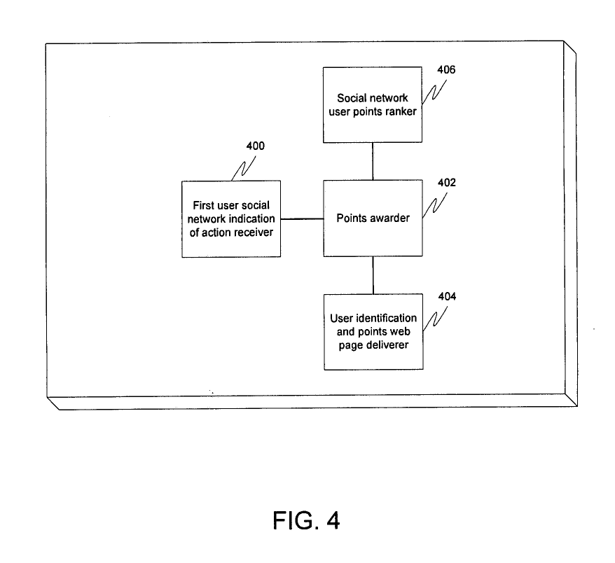

FIG. 4 is a block diagram illustrating an apparatus in accordance with an embodiment of the present invention. Each element of this apparatus may be implemented in hardware, software, or any combination thereof. A first user social network indication of action receiver 400 may perform step 300 of FIG. 3. A points awarder 402 coupled to the first user social network indication of action receiver 400 may perform step 402 of FIG. 1. A user identification and points web page deliverer 404 coupled to the points awarder 402 may perform step 304 of FIG. 3. A social network user points ranker 406 coupled to the points awarder 402 may perform step 306 of FIG. 3.

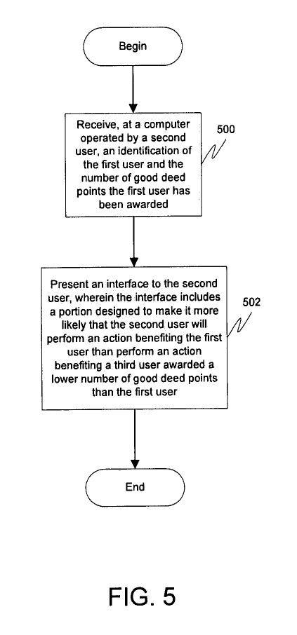

FIG. 5 is a flow diagram illustrating a method for utilizing good deed points awarded to a first user in a social network in accordance with an embodiment of the present invention. Each step of this method may be performed in hardware, software, or any combination thereof. At 500, an identification of the first user and the number of good deed points the first user has been awarded may be received at a computer operated by a second user. At 502, an interface may be presented to the second user, wherein the interface includes a portion designed to make it more likely that the second user will perform an action benefiting the first user than perform an action benefiting a third user awarded a lower number of good deed points than the first user.

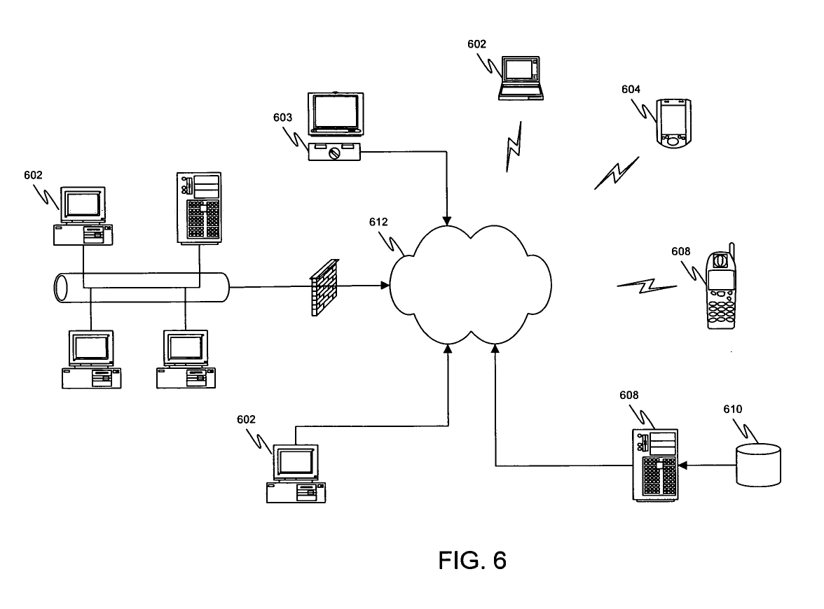

It should also be noted that embodiments of the present invention may be implemented on any computing platform and in any network topology in which presentation of search results is a useful functionality. For example and as illustrated in FIG. 6, implementations are contemplated in which the invention is implemented in a network containing personal computers 602, media computing platforms 603 (e.g., cable and satellite set top boxes with navigation and recording capabilities (e.g., Tivo)), handheld computing devices (e.g., PDAs) 604, cell phones 606, or any other type of portable communication platform. Users of these devices may navigate the network, and this information may be collected by server 608. Server 608 (or any of a variety of computing platforms) may include a memory, a processor, and a communications component and may then utilize the various techniques described above. The processor of the server 608 may be configured to run, for example, all of the processes described in FIG. 3. Server 608 may be coupled to a database 610, which stores information relating to the number of points awarded to the users. Applications may be resident on such devices, e.g., as part of a browser or other application, or be served up from a remote site, e.g., in a Web page (also represented by server 608 and database 610). The invention may also be practiced in a wide variety of network environments (represented by network 612), e.g., TCP/IP-based networks, telecommunications networks, wireless networks, etc. The invention may also be tangibly embodied in one or more program storage devices as a series of instructions readable by a computer (i.e., in a computer readable medium).

It should also be noted that the term “web page” shall be interpreted broadly to refer to any page that is displayed on an electronic device via transmission over a network. This may include, for example, pages displayed on web browsers on computers but may also include pages displayed on cellular phones, personal data assistants, media devices or other electronic devices.

While the invention has been particularly shown and described with reference to specific embodiments thereof, it will be understood by those skilled in the art that changes in the form and details of the disclosed embodiments may be made without departing from the spirit or scope of the invention. In addition, although various advantages, aspects, and objects of the present invention have been discussed herein with reference to various embodiments, it will be understood that the scope of the invention should not be limited by reference to such advantages, aspects, and objects. Rather, the scope of the invention should be determined with reference to the appended claims.

What is claimed is:

1. A method comprising:
receiving an indication that a first user of a social network has performed an action relating to helping a second user of the social network;
awarding a number of points to the first user based on the action performed; and
delivering a web page to a third user, wherein the web page contains an identification of the first user and a representation of the number of points the first user has been awarded, wherein the number of points the first user has been awarded are delivered in a way that allows them to be used to benefit the first user.

2. The method of claim 1, further comprising:
formatting the web page such that the identification of the first user appears in lieu of an identification of a fourth user if the first user has been awarded more points than the fourth user.

3. The method of claim 1, further comprising:
formatting the web page such that the identification of the first user appears more prominently than an identification of a fourth user if the first user has been awarded more points than the fourth user.

4. The method of claim 3, wherein the identification of the first user appears more prominently than the identification of the fourth user because either the identification of the first user appears higher on the web page than the identification of the fourth user or the identification of the first user appears in a larger size than the identification of the fourth user.

5. The method of claim 1, wherein the action is either getting a job for the second user of the social network or providing advice to the second user of the social network.

6. The method of claim 1, further comprising:
ranking one or more users of the social network based upon the number of points each has been awarded.

7. A method for utilizing good deed points awarded to a first user in a social network, the method comprising:
receiving, at a computer operated by a second user, an identification of the first user and the number of good deed points the first user has been awarded; and
presenting an interface to the second user, wherein the interface includes a portion designed to make it more likely that the second user will perform an action benefiting the first user than perform an action benefiting a third user awarded a lower number of good deed points than the first user.

8. The method of claim 7, wherein the interface is a web page.

9. A system comprising:
at least one computing device configured to:
receive an indication that a first user of a social network has performed an action relating to helping a second user of the social network;
award a number of points to the first user based on the action performed; and
deliver a web page to a third user, wherein the web page contains an identification of the first user and a representation of the number of points the first user has been awarded, wherein the number of points the first user has been awarded are delivered in a way that allows them to be used to benefit the first user.

10. The system of claim 9, wherein the at least one computing device is further configured to:
format the web page such that the identification of the first user appears in lieu of an identification of a fourth user if the first user has been awarded more points than the fourth user.

11. The system of claim 9, wherein the at least one computing device is further configured to:
format the web page such that the identification of the first user appears more prominently than an identification of a fourth user if the first user has been awarded more points than the fourth user.

12. The system of claim 11, wherein the identification of the first user appears more prominently than the identification of the fourth user because either the identification of the first user appears higher on the web page than the identification of the fourth user or the identification of the first user appears in a larger size than the identification of the fourth user.

13. The system of claim 9, wherein the action is either getting a job for the second user of the social network or providing advice to the second user of the social network.

14. The system of claim 9, wherein the at least one computing device is further configured to:
rank one or more users of the social network based upon the number of points each has been awarded.

15. An apparatus comprising:
means for receiving an indication that a first user of a social network has performed an action relating to helping a second user of the social network;
means for awarding a number of points to the first user based on the action performed; and
means for delivering a web page to a third user, wherein the web page contains an identification of the first user and a representation of the number of points the first user has been awarded, wherein the number of points the first user has been awarded are delivered in a way that allows them to be used to benefit the first user.

16. A program storage device readable by a machine tangibly embodying a program of instructions executable by the machine to perform a method comprising:
receiving an indication that a first user of a social network has performed an action relating to helping a second user of the social network;
awarding a number of points to the first user based on the action performed; and
delivering a web page to a third user, wherein the web page contains an identification of the first user and a representation of the number of points the first user has been awarded, wherein the number of points the first user has been awarded are delivered in a way that allows them to be used to benefit the first user.
